(19) United States
(12) Patent Application Publication
(10) Pub. No.: US 2007/0236924 A1
(43) Pub. Date: Oct. 11, 2007

(54) Solar-powered light for real estate and outdoor yard signs

(76) Inventors: James M. Personius, Fort Lauderdale, FL (US); Joe Loconte, Arlington Heights, IL (US)

Correspondence Address: John D. Long, PATENT COUNSEL;LONG & CHYBIK, Suite 115, 1575 Delucchi Lane, Reno, NV, 89502, US

(21) Appl. No.: 11/786,589

(22) Filed: Apr. 9, 2007

Related U.S. Application Data
(60) Provisional application No. 60/790,148, filed on Apr. 7, 2006.

(51) Int. Cl. F21L 4/00

(52) U.S. Cl. 362/183

(57) ABSTRACT

One possible embodiment of the invention could be signage illumination apparatus comprising a body, the body having generally an inverted U-shaped cross section substantially forming a channel that allows the device to straddle a support arm of a yard signage, the body generally supporting electronic circuitry that is substantially electrically connected to solar power cell(s), a rechargeable electrical storage device(s) and an illumination source(s). When light is generally energizing the solar power cell(s), the electronic circuitry may cause the resultant current from the solar power cell(s) to generally charge the rechargeable electrical power source(s) and not power the illumination device(s). When light is not generally energizing the solar panel(s), the electronic circuitry board may cause the charged rechargeable electrical power source (s) to discharge and power the illumination device(s) to illuminate at least a portion of the yard signage.

### CROSS REFERENCES TO RELATED APPLICATIONS/DOCUMENTS

This application claims the benefit under 35 U.S.C. § 119(e) of U.S. Provisional Patent Application No. 60/790,148 filed on Apr. 7, 2006, contents of which are relied upon and incorporated by reference.

### STATEMENT REGARDING FEDERALLY-SPONSORED RESEARCH OR DEVELOPMENT

Not Applicable.

### REFERENCE TO A “MICROFICHE APPENDIX”

Not Applicable.

### FIELD OF THE INVENTION

The present invention generally relates to the field of methods and apparatus for using solar power to illuminate outdoor yard signs.

### BACKGROUND

The growth of residential and commercial real estate construction and sales has generally propelled the real estate field into being one of America's largest industries. This field, particularly its residential side, generally relies heavily on advertisement through such media such as the Internet, industry multiple-listing databases, television, radio, telephone recordings, direct mail, and the like. Despite the continued march towards more sophisticated real estate advertising methodologies, one of the more critical and essential elements in the arsenal of real estate advertising generally remains the simple “FOR SALE” sign placed in the front yard of the property to be sold. Many in the real estate field consider the FOR SALE sign to be the one of the single most effective methods of communicating the availability of a property for sale or rent.

To date, however, the effectiveness of such signage has substantially been limited to daylight hours relying on sunlight to provide direct illumination for the signage. At hours of dusk and following darkness, the sign could remain otherwise so insufficiently illuminated so as to be generally unseen and thus unable to convey effectively the advertising message(s) to passersby (e.g., who may be prospective buyers for the property.) This incapacity, especially during the dark winter months in northern climes, could prevent the signage from effectively reaching persons, who may only be outside during dark hours (e.g., going to and from work and the like.)

Even the use of reflective backgrounds and lettering for the FOR SALE signage, which during dark hours generally relies upon headlight illumination from passing automobiles, only marginally improves signage effectiveness. In such cases, a majority of real estate signs may be too far from the road to effectively receive contact with the passing automotive headlight beams (they may at best provide scant and insufficient reflective illumination of the signage.) Further, the driver having his attention focused on the road ahead may not notice a dimly lit yard sign.

What is generally needed therefore is a substantially self-contained, rechargeable, solar powered lighting source that could be attached to real estate FOR SALE signs to provide signage illumination during at least some of the time during dark hours.

### SUMMARY OF THE INVENTION

### Advantages of One or More Embodiments of the Present Invention

The various embodiments of the present invention may, but do not necessarily, achieve one or more of the following advantages:

the ability to generally illuminate real estate and other yard signs during periods of darkness without generally relying upon a external power grid;

the ability to substantially enhance signage visibility to drivers, passengers, and passers-by during periods of darkness and poor visibility;

providing an illumination source for lighting signage, the illumination source having a generally self-contained power supply;

the ability to generally resist wind from blowing the illumination source off the sign;

the ability to generally increase real estate sales advertising effectiveness by promoting signage awareness and readability during periods of darkness and poor visibility;

providing an illumination source for lighting signage that may have lower electrifying costs than those systems being electrified from a power grid; and

the ability to light real estate and other outdoor yard signs without relying on external wires, extension cords, or cables to connect to a power grid.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a sign illumination apparatus comprising a body having an exterior generally defining a hollow interior, the body further having an inverted U-shaped cross-section forming an open channel that could at least partially receive and straddle a support arm of a sign frame, the support arm having a sign below it; the hollow interior further containing a electronic circuitry connected to at least one solar power cell, at least one rechargeable electrical power source, and at least one illumination device.

Another version of that embodiment could be a method of operating a sign illumination apparatus comprising of the following steps, but not necessarily in the order shown providing a signage with a support port and support arm, the support arm supporting a sign; providing a sign illumination apparatus having a body with an inverted U-shaped cross-section forming an open channel; receiving a portion of the support arm within the open channel.

Another version of that embodiment could be a sign illumination apparatus comprising a body means providing a channel means; a channel means for receiving a portion of a support arm of signage; and a solar light cell means for converting light into electricity, an electrical storage means for holding an electrical charge, an illumination means for lighting a sign, and circuitry means for controlling electricity.

The above-description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. In addition, it is to be understood that the phraseology and terminology employed herein are for the purpose of description and should not be regarded as limiting.

### DESCRIPTION OF THE DRAWINGS

FIG. 1 is substantially a perspective view of signage.

FIG. 2A is substantially a perspective view of one embodiment of the invention attached to signage.

FIG. 2B is substantially an end view of one embodiment of the invention attached to signage.

FIG. 2C is substantially a top view of one embodiment of the invention attached to signage.

FIG. 2D is substantially a side elevation view of one embodiment of the invention attached to signage.

FIGS. 3A, B, C, D, and E are substantially views of one embodiment of the invention attached to a support arm.

FIG. 3F is substantially a perspective view another embodiment of the invention attached to a support arm.

FIG. 4 is substantially a perspective view showing the interior of the invention

FIG. 5 is substantially a schematic of the circuitry design for the invention.

FIGS. 6 A and B are substantially views of the invention in operation.

FIG. 7 is substantially a flowchart for the operation of the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

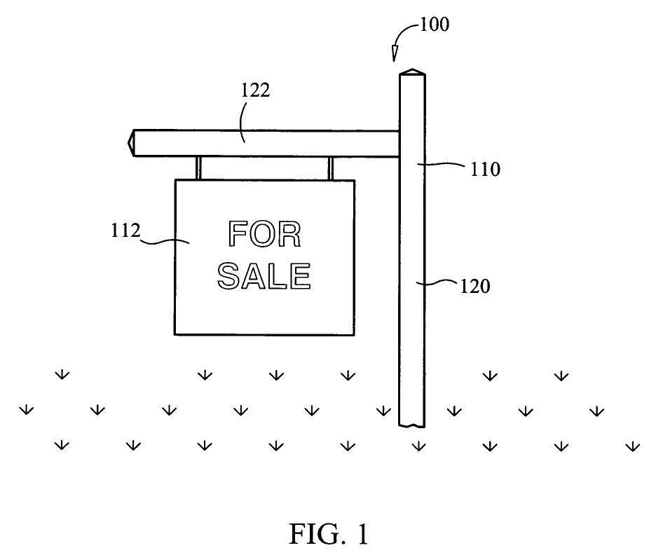

One embodiment of the invention could be a sign illumination apparatus 10 for yard signs such as real estate FOR SALE signage 100. As generally shown in FIG. 1, such signage 100 could comprised of a sign 112 (e.g., a painted plate or the like bearing advertising or other information indicia on both sides) attached to a sign frame 110. The sign frame 110 could be comprised of support post 120 that could be anchored vertically in the ground and a support arm 122 could generally be horizontally attached to the support post 120 at an end distal from the ground. In this manner, the support arm 122 could be held in a horizontal orientation away from the ground with sufficient clearance to allow generally the sign 110 to be suspended down from the bottom 123 of the support arm 122.

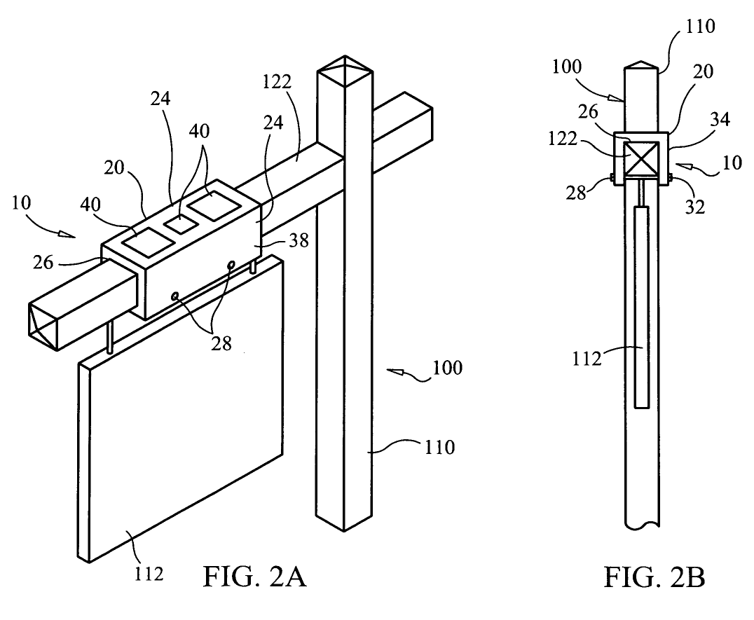

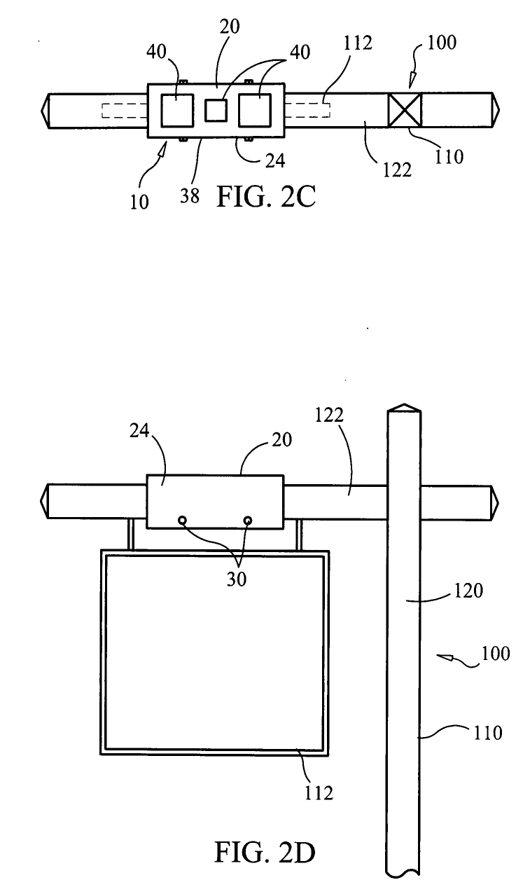

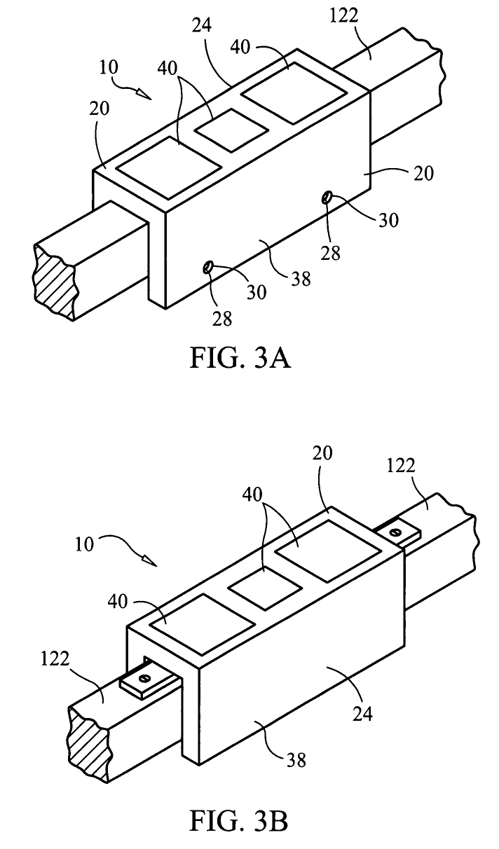

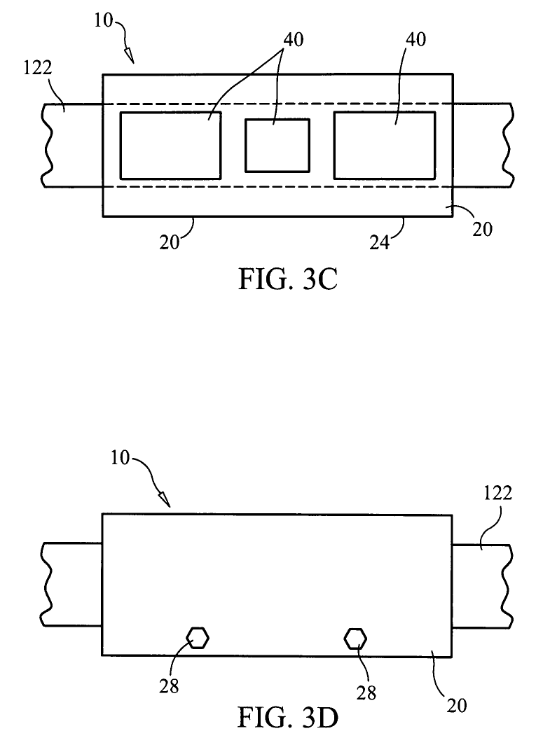

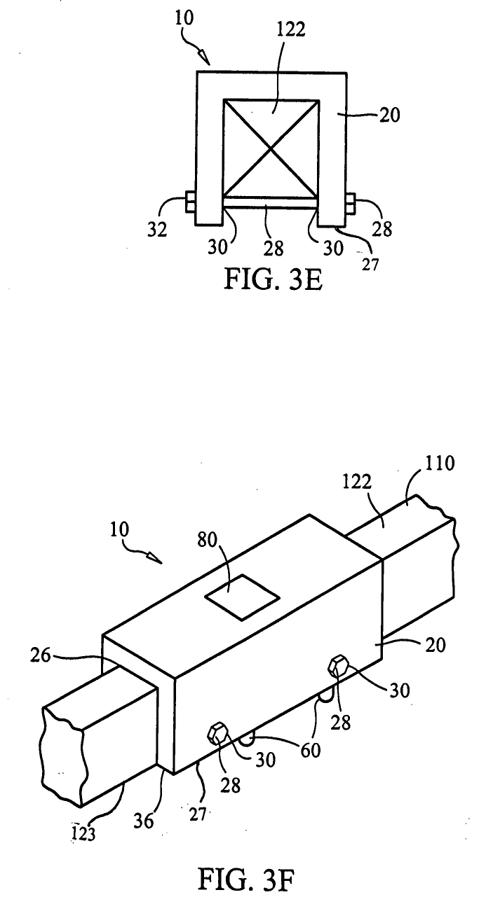

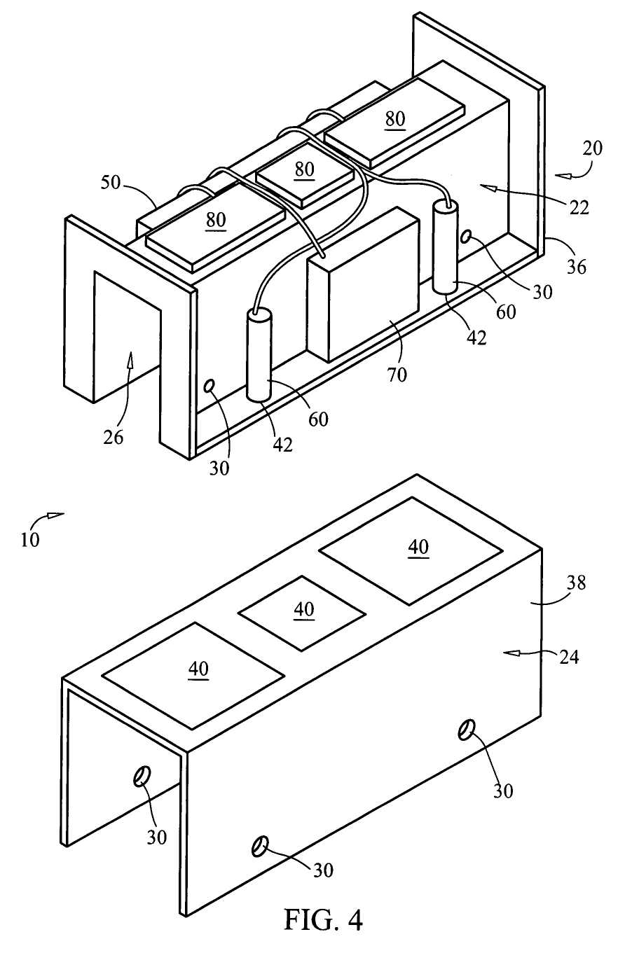

As generally shown in FIGS. 2-4E, the sign illumination apparatus 10 in at least be one embodiment could comprise of a body 20, electronic circuitry 50, solar power cell(s) 80, rechargeable electrical power source(s) 70, and illumination device(s) 60. The body 20 could generally comprise of an exterior 24 substantially defining a generally hollow interior 22. In one embodiment at least, the body 20 could generally have a box-like structure with a generally inverted U-shaped lateral cross section that forms a longitudinal open channel 26 on the bottom 27 of the body 22. The placement of the sign illumination apparatus 10 upon the sign frame 110 could be done so that the channel 26 could be reversibly placed up and over on a portion of the support arm 122 to allow the body 22 to substantially straddle at least a portion of the support arm 122. This positioning of channel 26 over the support arm 122 could generally locate the sign illumination apparatus 10 over the sign 112 in such a manner as to be capable of providing appropriate artificial illumination of both sides of the sign 112.

In at least one embodiment of the body 20, the depth of the open channel 26 could be greater than the height of the support arm 122 allowing portions of the body 20 to extend past the support arm 122 when the invention is applied to the support arm 122. Lateral apertures 30 in the body 20 could be adapted to reversibly receive fasteners 28 such as bolts that pass through the body 20 and under the bottom 123 of the support arm 122 to help lock the support arm 122 into the open channel 26. Nuts 32 applied appropriately to such fasteners 28 could secure the fasteners 28 to the body 20. In this manner, the invention could be securely, yet reversibly, attached to the signage 100. Other means of securing the sign illumination apparatus 10 to the signage 100 could be utilized and still be considered part of the invention.

In one embodiment, the body 20 could generally be a weather resistant plastic box 34 having a base 36 and a cover 38, the cover 38 generally applied to base 36 to generally seal in the interior 22 from the outside environmental elements. The interior 22 in one embodiment could house the electronic circuitry 50, the solar power cell(s), the rechargeable electrical power source 70, and the illumination source 60.

The cover 38 could have one or more translucent portions 40 (e.g., clear plastic) to admit sunlight into the interior 22. The base 36 similarly could have one or more translucent areas 42 to allow light (e.g., from the illumination source(s) 60) to pass through the body 20 to the outside environment.

The generally hollow interior 22 of the body 20 could house the electronic circuitry 50 (e.g. a circuit board); rechargeable electrical power source(s) 70, solar power cell(s) 80, and illumination source(s) 60. The solar power cells 80 could be located in the interior 22 in such a manner as to take the best advantage of the light admitted into the interior 22 through the translucent portion(s) 40 of the cover 38. The translucent areas 42 of the base 36 could be connected to respective illumination source(s) 60 so that light created by the illumination source 60 could pass through the translucent areas 42 out to outside environment. In one embodiment, the translucent areas 40 could be present on the bottom 27 of the body 20 (e.g., located on the bottom of those lower portions of the body 20, which extend down from the walls of the open channel 26.) The orientation of the translucent areas 42 upon the body 20 could allow the light from the illumination source(s) 60 to reach generally one or more areas of the signage 100 bearing information or other indicia (e.g., the sign 112).

As generally shown in FIG. 4E, another embodiment of the invention could lack the translucent portions 40 and the translucent areas 42. In this embodiment, the solar power cell(s) 80 could be mounted on the exterior 24 of the body 20 (e.g., top of the box 34) while the illumination source(s) 60 could be located on the bottom 27 of the body 20. The depth of the channel 26 could be such that it generally matches the height of the support arm 122. In this manner, the bottom 27 of the body 20 could be substantially flush with the bottom 123 of the support arm 112. As such, the lateral apertures 30 could direct the fasteners (e.g., wood screws) 28 into the sides of the support arm 122, rather than be directed below the support arm 122.

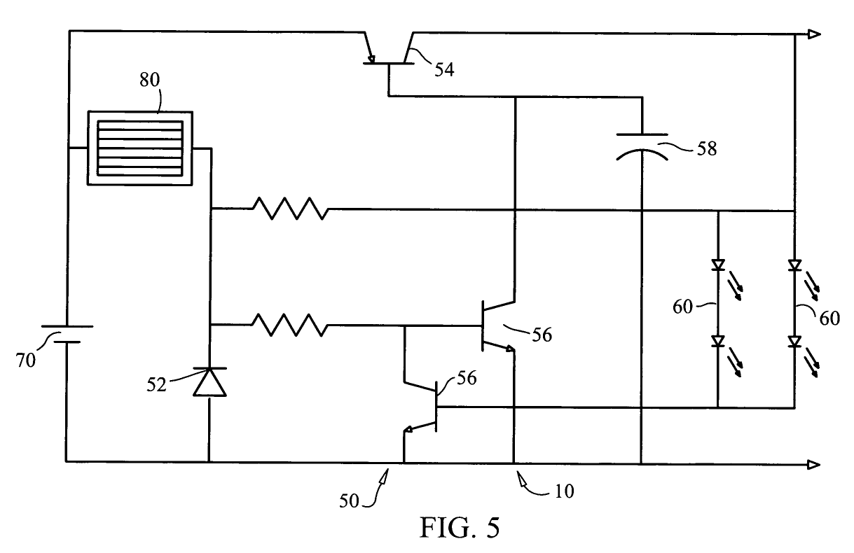

As generally shown in FIG. 5, the electronic circuitry 50 (e.g., a circuit board) could be connected to solar power cell(s) 80, rechargeable electrical power source(s) 70, and illumination device(s) 60 to control generally the movement of current to and from these devices. In one embodiment, the electronic circuitry 50, when sufficient light is present, could complete a solar powered recharging sub-circuit wherein at least one solar power cell 80 (rated at 5-6 volts) could be electrically being connected to and charge a rechargeable electrical power source(s) 70 such as a standard 12 volt Nickel-Cadmium rechargeable battery.

When solar power cell(s) 80 is not exposed to enough light to generally provide a sufficient charge to the rechargeable electrical power source(s) 70, the rechargeable electrical power source(s) 70 substantially moves current in the direction opposite that from the solar power cell recharging circuit. The diode 52, in response to movement of this current, generally interrupts the flow current from the rechargeable electrical power source(s) 70 to the solar power cell(s) 80.

The current from rechargeable electrical power source(s) 70 proceeds to a first transistor 54 (e.g., 2N3906), which may act like a switch to allow current to flow to a flip-flop sub-circuit, which may be generally comprised of two cross-connected 2N3904 transistors 56 and the 0.1 ohm capacitor 58 wherein the capacitor 58 generally acts as a timer for the flip-flop sub-circuit. The flip-flop sub circuit could be connected to the illumination source(s) 80 (e.g., LC 2000ETW-50 LEDs) alternately sending power to the illumination source(s) 80 so to cause them to strobe (turning on and off at a high rate of speed). This strobe function allows the illuminating sources 80 to use substantially less power than when the illumination source(s) 80 is constantly on and therefore allow the invention to provide for longer periods of illumination during dark hours operation.

As stated above, when sufficient sunlight is present the solar power cells 80 could receive the sunlight and convert it into electrical current passed to the electronic circuitry 50. The electrical circuitry 50 at this time could otherwise prevent the current from passing to the flip-flop sub circuit to power the illumination source(s) 60 (and instead charge the rechargeable power source 70.)

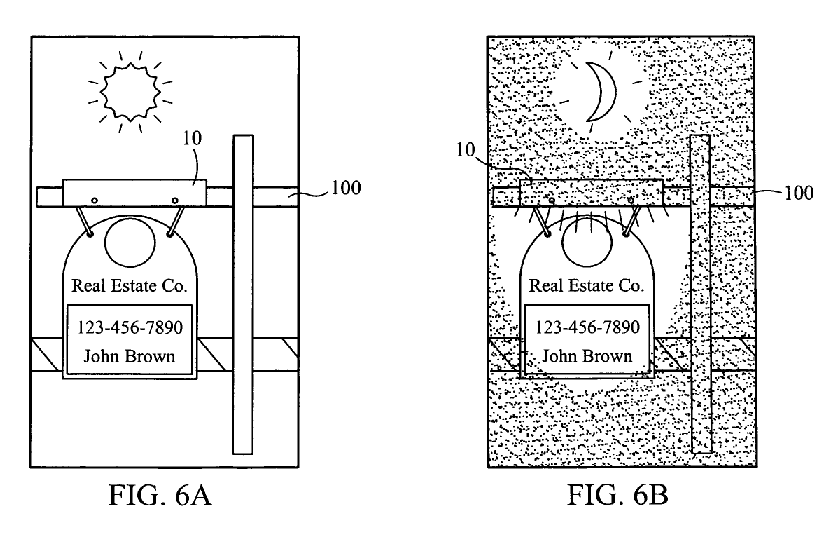

As substantially shown in FIGS. 6A and B, light from the illumination source(s) 60 could substantially emanate from the body 22 to shine generally upon both sides of the sign 112, allowing passer-bys, motorists, and other to see the sign 112 generally during dark hours and generally be aware of the indicia on the sign 112.

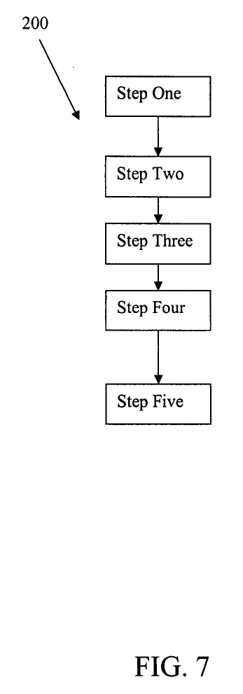

As substantially shown in FIG. 7, one possible process 200 for operating the invention could start with step one, location of suitable signage. Here, the operator could identity a signage that needs to be illuminated during dark hours. This action could include verifying the signage structure has suitable support arm that is generally horizontally located above the ground and has a sign suspended beneath the support arm. The operator could also check to see if the width of the support arm is appropriate so that at least a portion of the support arm could be received within the open channel of the body. As step one is substantially completed, the process 200 could then proceed unto step two, placement of the invention.

In step two, placement of the invention, the operator could place the body so that it straddles at least a portion of the support arm in that the channel is generally placed over a top portion of the support arm. The body could be located on the arm so that the illumination sources could generally place their lighting effect on both sides of the sign. At the substantial completion of step two, the process 200 could proceed unto step three, securing the invention.

In step three, securing the invention, the operator could place at least one fastener into at least one of the lateral apertures. In the embodiment of the invention wherein the depth or height of the open channel is greater than the height or depth of the support arm, then the fasteners could be directed underneath the support arm to secure the body to the support arm. In other embodiments wherein the depth of the support arm is equal or greater that that depth of the channel, then the fastener as it passes through a lateral aperture could be directed into the side of a support arm. As step three is substantially completed, the process could proceed onto step four, electrical operations.

In step four, electrical operations, if sufficient sunlight is present, the solar power cell(s) could receive light and convert it into electrical current. This electrical current could passed onto the electronic circuitry to charge (or recharge) the rechargeable electrical power source(s) 70. The electrical circuitry 50 at this time generally prevents powering of the illumination source(s).

If insufficient sunlight is present then, the electrical circuitry could allow the rechargeable electrical power source(s) (if it is holding sufficient electrical charge at the time) to generally discharge and to power the illumination source (e.g., via strobe effect). The subsequent light from the illumination source(s) could substantially emanate from the body to shine generally upon both sides of the sign, allowing passer-bys, motorists, and others to see the sign generally during dark hours and generally be aware of any indicia on the sign. Upon the substantial completion of step four, (e.g., the invention has sufficiently illuminated the sign enough times during dark hours to accomplish the purpose of the sign [e.g., selling a house]), the process 200 could proceed to step five, removal of the sign.

In step five, removal of the invention, the operator could reverse the process of step three (e.g., remove the fasteners) and step two (e.g., take the body off the support arm) to remove the body from the signage. The operator could then place the invention in storage until it was needed again. When the device is needed again, the operator could repeat process 200 as necessary.

### CONCLUSION

As shown and described above, the invention generally has the ability to generally illuminate real estate and other yard signs during periods of darkness without generally relying upon a power grid so as to allow passersby, drivers, passengers, and other to be aware of the information contained in the signage's indicia that would otherwise be obscured by the lack of light during dark hours of the day.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A sign illumination apparatus comprising:
(A) a body having an exterior defining a hollow interior, the body further having an inverted U-shaped cross-section forming an open channel that could at least partially receive a support arm of a sign frame, a sign being located below the support arm;
(B) the hollow interior further containing a electronic circuitry connected to at least one solar power cell, at least one rechargeable electrical power source, and at least one illumination device,
wherein when light is energizing the solar power cell, the electronic circuitry directs current from the solar power cell to charge the rechargeable electrical storage device and not to power the illumination device and when light is not energizing the solar power cell, the electronic circuitry board allows an at least partially-charged, rechargeable electrical storage device(s) to discharge and power the illumination device.

2. A sign illumination apparatus of claim 1, wherein the solar power cell is located within the interior.

3. A sign illumination apparatus of claim 2, wherein exterior further comprises one or more translucent portions, which allows light to pass through the exterior to the solar power cell.

4. A sign illumination apparatus of claim 1, wherein the illumination source is located in the interior.

5. A sign illumination apparatus of claim 4, wherein the exterior further comprises a one or more translucent areas, which allows light from the illumination source to pass through the exterior of the body to the outside environment.

6. A sign illumination apparatus of claim 1, wherein the body further comprising lateral apertures that allow fasteners to pass through the body to lock at least a portion of the support arm in place within the channel.

7. A sign illumination apparatus of claim 1, wherein the lateral apertures are located proximate to the channel that could at least partially receive a support arm of a sign frame.

8. A sign illumination apparatus of claim 7, wherein the fasteners pass through the lateral apertures and underneath the support arm.

9. A sign illumination apparatus of claim 1, wherein the illumination sources are located proximate to the open channel that could at least partially receive a support arm of a sign frame.

10. A method of operating a sign illumination apparatus comprising of the following steps, but not necessarily in the order shown:
(A) providing a signage with a support post and support arm, the support arm supporting a sign;
(B) providing a sign illumination apparatus having a body with an inverted U-shaped cross-section forming an open channel;
(C) receiving a portion of the support arm within the open channel; and
(D) providing illumination of sign.

11. A method of claim 10 further comprising of a step of straddling at least a portion of the support arm with the body.

12. A method of claim 10 further comprising of a step of placing fasteners through the body and underneath the support arm.

13. A method of claim 10 further comprising of a step placing the bottom of the support arm flush with the bottom of the body.

14. A sign illumination apparatus comprising:
(A) a body means proving a channel means;
(B) a channel means for receiving a portion of a support arm of a signage; and
(C) a solar light cell means for converting light into electricity;
(D) an rechargeable power means for storing an electrical charge;
(E) an illumination means for lighting a sign; and
(F) circuitry means for controlling electricity from the solar light cell means to the electrical storage means and electricity from the rechargeable power means to the illumination means.

15. A sign illumination apparatus of 14 wherein the body means has an inverted U-shaped cross-section forming the channel means.

16. A sign illumination apparatus of 14 wherein the channel means further allows the body means to straddle a portion of the support arm.

17. A sign illumination apparatus of 14 wherein the illumination means is located proximate to the channel means.

18. A sign illumination apparatus of 14 further comprises a fastener means located proximate to the channel means.
